(19) United States
(12) Patent Application Publication
(10) Pub. No.: US 2016/0338545 A1
(43) Pub. Date: Nov. 24, 2016

(54) METHOD AND SYSTEM FOR STORING, PROCESSING AND COOKING FOOD

(71) Applicant: Umm Al-Qura University, Makkah (SA)

(72) Inventors: Noman Ahmed Shah, Makkah (SA); Imran Ahmed Shah, Lahore (PK); Kamran Ahmed Shah, Leeds (GB)

(73) Assignee: Umm Al-Qura University

(21) Appl. No.: 14/718,176

(22) Filed: May 21, 2015

(51) Int. Cl. A47J 44/00

(52) U.S. Cl. CPC A47J 44/00

(57) ABSTRACT

A system for storing and cooking food comprises or consists of a computer having a control module, data storage, an input and an Internet connection. The system also includes a refrigeration unit having a freezer, a refrigeration station, a heating unit including a microwave oven as well as a convection oven, a grill, a 3D food printer and a transfer mechanism for transporting food from a storage facility to a microwave oven and/or a convection oven. In addition, a control mechanism delivers preselected frozen food from the freezer to the microwave oven and a transfer mechanism delivers defrosted food to the convection oven. The system further includes a clock and a timer, a liquid sprayer for basting the food and an alarm to indicate that the food is ready by a third transfer mechanism for moving the food to a warming oven.

### FIELD OF THE INVENTION

This invention relates to a novel method and system for storing, processing and cooking food and more particularly to an automated or semi-automated method and system for storing, processing and cooking food that can be accomplished by untrained individuals with little or no training in the art of cooking.

### BACKGROUND OF THE INVENTION

Automated food preparation systems have been developed over the past twenty or more years and many of such systems are in use today. For example, a U.S. Patent Application Publication No. 2003/0139843 of Hu et al. discloses an Automated Cooking System for Food Accompanied by Machine Readable Indicia. As disclosed, the system includes readable indicia such as a bar code that is read by a reader. Cooking data, including function coefficients, are accessed from an Internet server based on the information in the bar code. An oven cooks the food in phases in response to the cooking data and one or more monitored food parameters of humidity, temperature and weight. The cooking is controlled by functions in which one or more food parameters are multiplied by coefficients that vary according to food type.

A second U.S. Pat. No. 7,762,181 of Boland et al. discloses a Customized Nutritional Food and Beverage Dispensing System. The system dispenses a customized nutritional serving that is made up of ingredients stored within a device incorporating the system. The device has a controller in whose memory is stored an inventory of the ingredients available in the device, their compositions and properties and customer profile data. The controller is programmed to formulate a serving which best matches the customized serving selected by the customer within constraints set by the programming taking into account the inventory of ingredients and the health profile of the customer. The customer is then presented with the selected serving and either accepts it or modifies it. The device is then programmed to prepare and dispense the final selection.

Finally, a U.S. Pat. No. 8,261,980 of Scutellaro et al. discloses an Automated Food Service and Billing System and Method. As disclosed, an automated restaurant includes a plurality of food delivery locations and a food preparation area. A computer system is in electronic communication with the food delivery locations and the food preparation area. Visual content stored in the computer system is displayed on display screens at each of the food delivery locations. The visual content may include information relating to a customer food order which is stored in the computer system for later delivery to a corresponding food delivery location as well as entertainment. The customer may directly enter a food order and pay for the order at the food delivery location.

Notwithstanding the above, it is presently believed that there is a current need and a potential commercial market for an improved method and system for storing, processing and cooking food in accordance with the present invention. Such systems are customized to meet the demands of individual restaurants or the like.

### SUMMARY OF THE INVENTION

A system for storing, processing and cooking food in accordance with the present invention includes a computer including a control module, data storage for storing a plurality of recipes including cooking instructions, and an input module and Internet connectivity. In addition, the system includes a refrigeration unit including a freezer for storing a plurality of frozen food or meal kits, a 3D food printer for preparing layers of defrosted food products, a cooking unit including a microwave oven, a convection oven, a deep fryer, a boiling station and control means for defrosting frozen foods and cooking defrosted foods as well as a timer and alarm for indicating when the cooking is done.

In addition to the above, the system including the control means provides a first transfer mechanism for delivering a preselected frozen food from a freezer to a microwave oven, defrosting the frozen food in the microwave oven and a second transfer mechanism including the control unit for transporting a defrosted meal kit from the microwave oven to a convection oven or other cooking unit and cooking the foods. The timer and the alarm and a third transfer mechanism respond to the control unit to indicate that the cooking of the first portion of a meal is completed and that it is time to transfer that portion of the meal to a remote warming oven.

The invention will now be described in connection with the accompanying drawings.

### DESCRIPTION OF THE DRAWINGS

FIG. 1 is a flowchart illustrating a system for storing, processing and cooking foods in accordance with a first embodiment of the invention;

FIG. 2 is a schematic illustration of the invention as shown in FIG. 1;

FIG. 3 is a flowchart illustrating the controls for a system in accordance with the present invention; and

FIG. 4 is a flowchart illustrating the controls, components and alternatives for a system in accordance with the present invention.

### DESCRIPTION OF THE PREFERRED EMBODIMENTS OF THE INVENTION

The preferred embodiments of the invention provide an automated or semi-automated processing and cooking of food and meal kits with minimal interaction for processing and cooking. The system typically includes electrical and/or electrical connections, a source of water, a refrigeration unit including a freezer and conventional refrigerator for storing food.

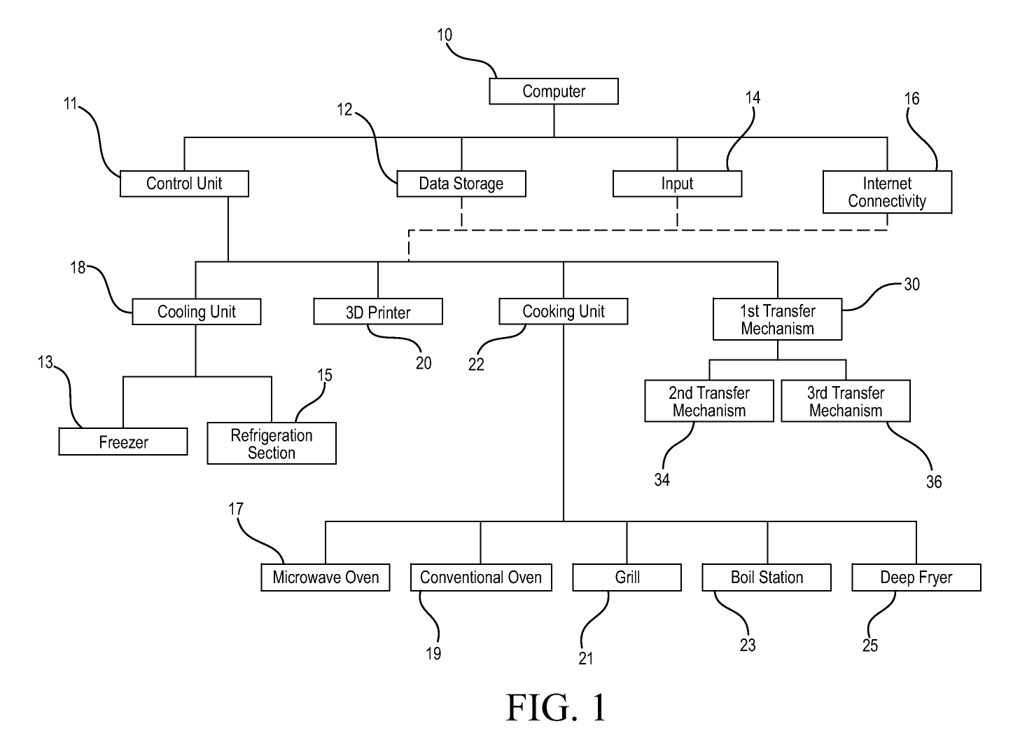

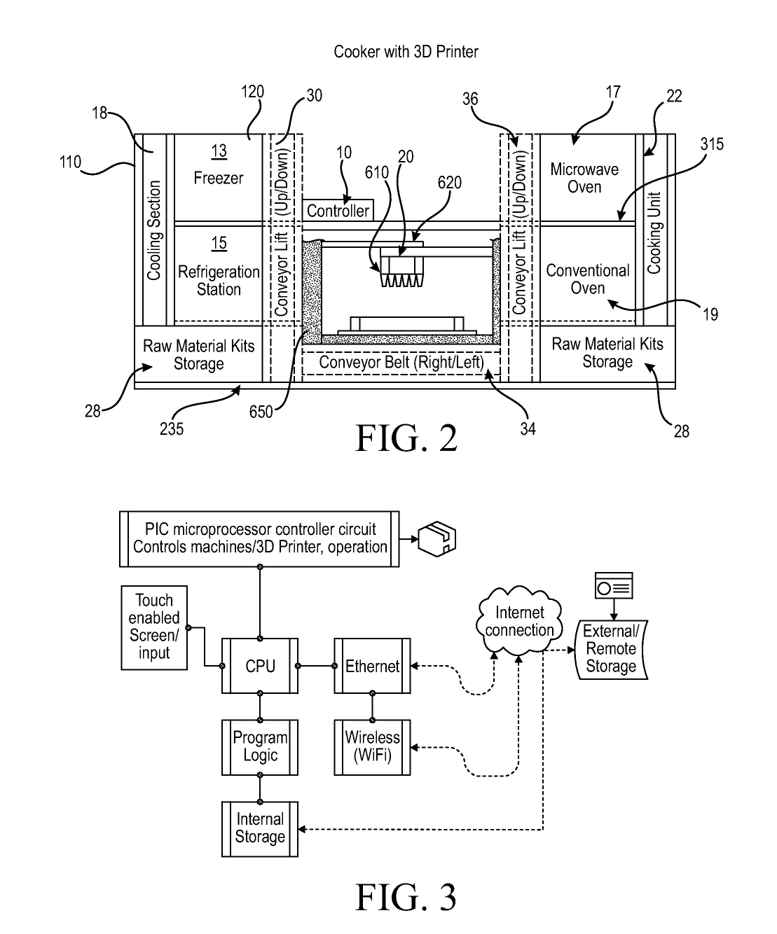

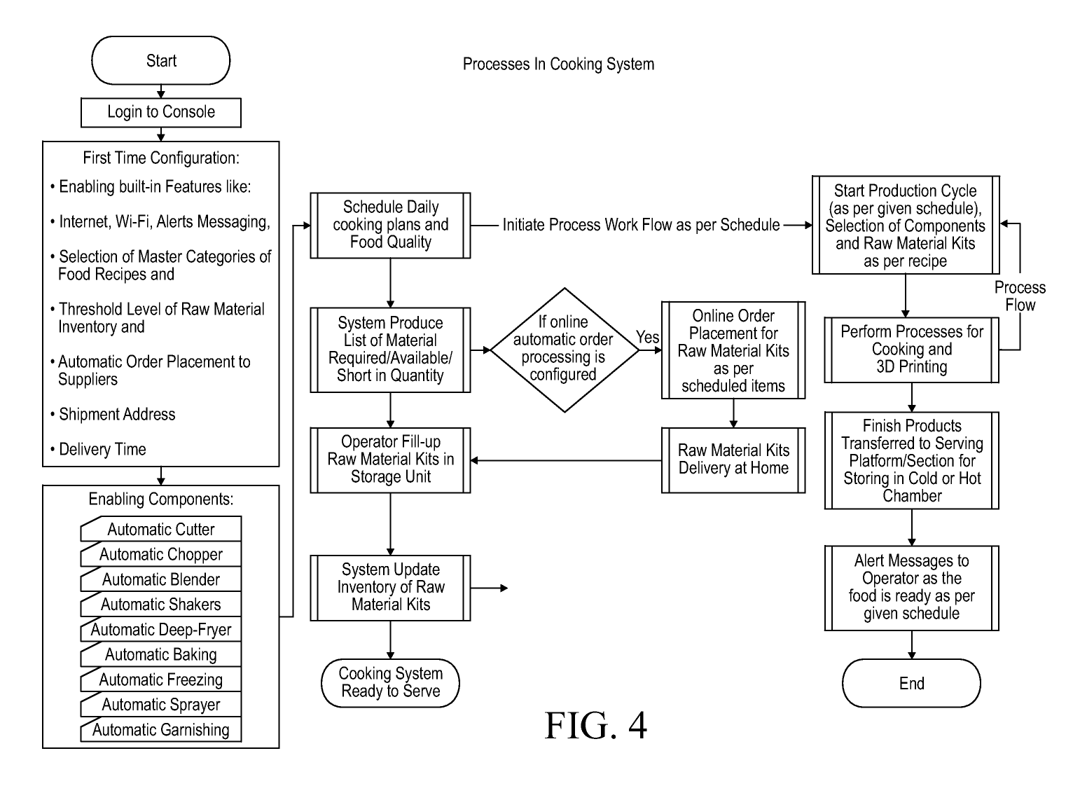

As shown in FIG. 1, a system for storing, processing and cooking foods as for example meal kits includes a computer 10 or a central processing unit. The computer 10 includes a control module 11, a data storage unit 12 for storing a plurality of recipes including cooking instructions. The computer 10 may also include a clock and/or timer plus a control mechanism and a liquid dispenser 9 for basting meats or the like as well as a control mechanism for regulating cooking temperatures and times. The system also includes an input module 14 and Internet connection 16.

The system in accordance with a first embodiment of the invention is connected to a cooling unit 18 that includes a refrigeration unit having a freezer 13 and refrigeration station 15. In addition, the computer 10 is connected to a 3D food printer 20 for preparing layered foods as well as a cooking unit 22. The cooking unit 22 has a microwave oven 17, a convection oven 19 as well as a grill 21, boiling station 23 and deep fryer 25 as well as a storage unit 28.

In one embodiment of the invention the system includes a first transfer mechanism 30 that may include a first transfer mechanism 31 that may include robots, conveyer belts and lifts for selecting a first food or meal from a first storage compartment 28 that is a frozen storage and transferring the selected food to the microwave oven 17 wherein the food is defrosted in accordance with the cooking instructions.

A second transfer mechanism 34 opens the door of the microwave oven, grasps the defrosted food and delivers the defrosted food items to the convection oven 19 wherein it is baked or roasted according to instructions from the data storage unit 12. The roasting is conducted using the water spray unit 9 as programmed by the storage unit 12 or by a bar code or the like. The system may also include a third transfer mechanism 36 for garnishing and/or delivery to a warming oven 35.

An important feature in a first embodiment of the invention resides in the use of food or meal kits that may include a protein such as meat, starch such as a potato or bread, vegetable and/or fruits and a desert. In a basic system, the meal kits or a plurality of meal kits are ordered and manually arranged in a freezer 13 with units for individual kits while cooking instructions or recipes for various meals are stored in data storage 12 of the computer 10. The computer 10 implemented system allows an individual to select a meal from a plurality of frozen meals including a time for preparing the meal and transferring the meal from storage units 28 to a microwave oven 17 for defrosting.

After defrosting the meal kit may be divided and cooked in a convection oven 19 or portions thereof in a microwave oven 17 in accordance with the cooking instructions and/or recipe from data storage 12 and subsequently transferring the cooked food to a warming oven 35 and reassembled into a meal for an individual.

The following components are incorporated in one or more embodiments of the invention.

A control unit; operator console (Input/Output Unit with Touch Display, Audio I/O, Keyboard, Mouse); a 3D printing unit, for printing status, progress, recipe, debug and error information and possibly photographs of cooked food; processing and microcontroller unit (hardware & software); Internet connectivity 16 and; data storage; software application; mobile device application; monitoring unit; dry/wet temperature and humidity sensors; and smoke and fire detectors. Logistics and transmission unit; conveyor belts; conveyor lifts; conveyor trays; robotic arms; filtration unit; rollers; and containers are also included in connection with or integral with the control unit.

Storage units 28; freezing units; refrigeration section 15; temperature controlled storage units 28 for raw material kits; raw material storage; crockery; food packaging; and temperature controlled storage units for finished products are also provided.

Components for cooking and a preparation unit; microwave oven 17; grill 21; cutter; chopper; blender; shaker; deep fryer 25; baking unit; sprayer; garnishing and spraying unit; dry hot air blower unit; packaging unit; and boiling station 23 may be included. A 3D food printing unit i.e. a specialized 3D food printer may also be included.

### Operation

The operation of the disclosed invention is described as follows:

In order to make the device operational, an operator will connect this installation or machine for drinking water, electricity, timer and other necessities.

An operator will then feed raw material and/or pre-packaged kits into the related storage unit. The operator then selects pre-recorded recipes from the stored data.

Alternatively, the user may install/transfer from interlinked connected device like a smart phone for further instructions.

The operator may purchase open standard recipes or special recipes online through built-in features of the console or application running on any interlinked device like a smart phone.

Upon selection of a food preparation recipe, disclosed system/device/machine will produce a list of required material (items or kits) and send it to an output unit.

A device in accordance with the invention should be machine smart and confirms what kits are required, whether these kits have to be ordered or if already available to prepare the required quantity of the selected food products. If any of the required material kit(s) are not available in inventory according to internal records, the device will advise the operator to make necessary arrangements which may include online order processing through specific or related vendors or suppliers.

The operator arranges for immediate delivery or substitute raw materials in desired quantity from a supplier or notify the operator that an order cannot be completed.

As soon as the raw material kits are available in required quantity, the system/device/machine will prepare/cook the scheduled quantity of the food products according to the selected recipes. Then the food item will be locally prepared when it is needed and available for consumption or storage.

Alternatively, the operator of the machine may be able to develop/compose and record new recipes for preparation of food using console, interlinked device and with the help of pre-recorded templates.

The device will confirm that depending upon available resources and limitations (type and quantity of stored raw material and kits, fuel, electricity and time constraints) which recipes, in which quantity (may be cooked) and are selectable for preparation.

### System and Devices

A device in accordance with the present invention will process food and move prepared food items into a warming oven or a delivery line and may inform the operator through an alarm that food is ready or alternatively will move food to a pre-programmed or desired storage area. Food storage and disposal units will have disconnected systems so that an operator can store or remove the items from the machines. A component of the control unit comprises software, hardware, sensors, various monitoring cameras and mechanical systems to guide and monitor the process and assists in maintenance, safety, security, cleaning and repair and will ensure a fail safe operation.

Computer related systems (method/systems/apparatus including computer program products) operable to perform operations including some common functions like online order processing and supply chain management for physical products and inventory (like 3D printing kits inks) and also performs specialized innovative functions which includes remote printing and cooking of food and other products.

The System/Apparatus may include a cooling chamber, freezer as well as a defroster. In addition, the total system includes a heating chamber or convection oven that can provide dry heating for kits, storage, kits changer, conveyor belt and conveyor lift, conveyor trays, 3D printing conical heads, garnishing unit, display unit/touch enabled screen for input, system controller, Ethernet and Wi-Fi for Internet connections.

A home cooking 3D printer chef serves as a conventional 3D printer but it also serves as a skilled chef to cook specialized food products that a person usually likes to eat. The disclosed invention takes instructions coded along with recipe, (to load related food products or kits from data storage) and cooking or printing and as soon as the order is ready, it rings a bell to pick up your order.

The 3D food printing is well known in the field and is being manufactured to industrial needs as well as home users. Home 3D printers are also used to print customized cakes, pastries and other food items. 3D printing manufacturers also have formed common standard functionalities for common printers to facilitate users to use the same recipe to print from 3D printer. But 3D printers could not replace the home cooking and chef yet because of its limitations to the printing and lacking cooking features.

The claimed invention has a comprehensive system containing the deficient parts of the common 3D printers such as temperature controlled storage related to cooking raw material and 3D printing inks, chilled freezing chamber and refrigeration chamber controlled by a cooling section. Defrost and dry heating chamber and oven heating chamber controlled by a heat exchanger, changer kits changer for raw material kits and finished products using a conveyor lift, conveyor belts and conveyor trays, 3D printing conical heads, garnishing unit, display unit/touch enabled screen for input, system controller, Ethernet and Wi-Fi for Internet connection whereas all the things are smartly connected to work efficiently as a home cooking 3D printing chef.

In some of its embodiments the claimed system/method can prepare a Asian/Arabian wheat bread (aka Chapati or Roti or peratha) by spreading a dove, roller makes its round and thin, conveyor belt transfer this bread to oven and as soon as its backed, again it is transferred to hot chamber (where it is kept hot until it is served) and this function is replicated to prepare the required quantity. If the recipe includes oil, or linseed garnishing, a garnishing unit will garnish linseed oil sending breads to baking oven unit and spray cooking oil on the bread. At the other hand, it may perform a deep frying cooking function for chicken roast, french fries including pre-requisite associated functions like peeling and cutting potatoes, as well as boiling and cutting to serve vegetables, making ice cream trifle and putting them in a chilled cold chamber.

While the invention has been defined in accordance with its preferred embodiments, it should be recognized that changes and modifications may be made therein without departing from the scope of the appended claims.

What is claimed is:

1. A system for storing, processing and cooking food, said system comprising:
a computer including a control module, data storage for storing a plurality of recipes including cooking instructions, an input module and Internet connectivity;
a refrigeration unit including a freezer for storing a plurality of meal kits, a 3D food printer for preparing layers of defrosted food products, a cooking unit including a microwave oven, a convection oven, a deep fryer, a boiling station and control means for defrosting frozen foods and cooking defrosted foods;
means including said control module for delivery a preselected frozen food kit from said freezer to said microwave oven and defrosting said frozen food kit in said microwave oven; and
second means including said control unit for transporting said defrosted meal kit from said microwave oven to said convection oven and cooking the foods in said meal kit according to a recipe from said data storage;
a timer and alarm and third transport means for response to said control unit to indicate that the cooking of the first portion of a meal is completed and that it is time to transfer that portion of the meal to a warming oven.

2. The system for storing, processing and cooking food according to claim 1, in which said convection oven includes a supply of liquid and means for spraying the liquid onto a meal during cooking of the meal.

3. The system for storing, processing and cooking food according to claim 2, in which said control unit includes a visual display for indicating the meal ingredients identification and the number of such meals in storage.

4. The system for storing, processing and cooking food according to claim 3, which includes means for automatically ordering additional food kits when inventory of food kits is reduced to a preselected number.

5. The system for storing, processing and cooking food according to claim 4, which includes a garnishing unit.

6. The system for storing, processing and cooking food according to claim 5, that includes a water supply and a temperature controlled storage unit for cooked meals.

7. A system for storing, processing and cooking food, said system consisting of:
a computer including a control module, data storage for storing a plurality of recipes including cooking instructions, an input module and Internet connectivity;
a refrigeration unit including a freezer for storing a plurality of frozen food, a 3D food printer for preparing layers of defrosted food products, a cooling subsystem, a cooking unit including a microwave oven, a convection oven, a deep fryer, a grill, a boiling station and control means for defrosting frozen foods and cooking defrosted frozen foods, a timer, an alarm for indicating when the cooking is done;
means including said control module, a conveyer, a robot arm for conveying a frozen food to said microwave oven and defrosting said frozen food and conveying said food from said microwave oven into said convection oven and cooking said defrosted food according to a selected recipe;
a timer and alarm and further transfer means for in response to said control unit to indicate that the cooking of said food is done and a third mechanism for transferring said cooked food to a warming oven.

8. The system for storing, processing and cooking frozen food according to claim 7, in which said convection oven further consists of a supply of liquid and sprays disposed in said oven for spraying said liquid on said food during cooking thereof which further includes a garnishing unit for garnishing the food and which includes means for automatically ordering additional food when the inventor of food is reduced to a preselected level and means for entering recipes and cooking directions in data storage for additional foods.

9. A method for storing, processing and cooking food, said method comprising the following steps:
providing a computer including a control module, data storage for storing a plurality of recipes and cooking instructions, an input module and Internet connectivity;
providing a refrigeration unit including a freezer for storing a plurality of frozen food, a 3D food printer for preparing layers of defrosted food products, a cooking unit including a microwave oven, a convection oven, a deep fryer, a grill, a boiling station and control means for defrosting frozen food and cooking defrosted foods; and
a first transfer mechanism for transporting frozen food from said freezer to and into said microwave oven, defrosting said frozen food in said microwave oven, second mechanism for transferring said defrosted food into said convection oven, cooking said defrosted food in said convection oven and third mechanism for transferring said cooked food to a warming oven.

10. A method for storing, processing and cooking food, said method consisting of:
providing a computer including a control module, data storage for storing a plurality of recipes and cooking instructions, an input module and Internet connectivity;
providing a refrigeration unit including a freezer for storing a plurality of frozen food, a 3D food printer for preparing layers of defrosted food products, a cooking unit including a microwave oven, a convection oven, a deep fryer, a grill, a boiling station and control means for defrosting frozen food and cooking defrosted foods; and
a first transfer mechanism for transporting frozen food from said freezer to and into said microwave oven, defrosting said frozen food in said microwave oven, second mechanism for transferring said defrosted food into said convection oven, cooking said defrosted food in said convection oven and third mechanism for transferring said cooked food to a warming oven.
